(19) United States
(12) Patent Application Publication
(10) Pub. No.: US 2016/0162185 A1
(43) Pub. Date: Jun. 9, 2016

(54) DATA PROGRAMMING FOR A MEMORY HAVING A THREE-DIMENSIONAL MEMORY CONFIGURATION

(71) Applicant: SANDISK TECHNOLOGIES INC., PLANO, TX (US)

(72) Inventors: MANUEL ANTONIO D'ABREU, EL DORADO HILLS, CA (US); STEPHEN SKALA, FREMONT, CA (US)

(73) Assignee: SANDISK TECHNOLOGIES INC.

(21) Appl. No.: 14/561,446

(22) Filed: Dec. 5, 2014

(51) Int. Cl. G06F 3/06; G06F 11/07

(52) U.S. Cl. CPC G06F 3/061; G06F 3/0653; G06F 3/0659; G06F 3/0683; G06F 11/073; G06F 11/076; G06F 11/0793

(57) ABSTRACT

A data storage device includes a memory die. The memory die includes a memory having a three-dimensional (3D) memory configuration. A method includes sensing information stored at a region of the memory to generate sensed information. The method further includes adjusting one or more write parameters associated with the region in response to an error rate associated with the sensed information satisfying an error threshold.

### FIELD OF THE DISCLOSURE

This disclosure is generally related to memories and more particularly to write processes for memories.

### BACKGROUND

Non-volatile data storage devices have enabled increased portability of data and software applications. During operation of a storage device, data may be programmed to the storage device, read from the storage device, and erased from the storage device. As a storage device is used, the storage device may experience physical wear that causes a number of errors in data to increase. For example, multiple program/erase cycles may cause physical wear to storage elements of a storage device, resulting in more errors.

A storage device may encode and decode data using an error correcting code (ECC) technique to correct certain errors in data. For example, an ECC technique may use parity information to correct one or more errors in data. In some cases, the number of errors in data can exceed the error correction capability associated with the particular ECC technique used to encode the data, which may cause loss of user data.

Some storage devices may “close” a block to write operations in response to a threshold number of program/erase cycles of the block. Closing a block to write operations may reduce or avoid loss of user data. However, closing a block to write operations reduces available storage capacity of a storage device.

### SUMMARY

A data storage device may include a memory die having a memory with a three-dimensional (3D) memory configuration. As the data storage device undergoes operation (or “ages”), data errors may increase (e.g., due to physical wear to storage elements of the memory). To improve performance, the data storage device may utilize an adaptive write process that compensates for aging of the memory. An adaptive write process may be a 3D-specific process that utilizes one or more physical characteristics of a 3D memory configuration in order to improve performance (e.g., to reduce errors in stored data).

To illustrate using an example implementation, an adaptive write process may include writing information to a block (e.g., during a first stage of the adaptive write process) and monitoring the block (or other region) of the memory to determine if an error rate associated with the block satisfies an error threshold, such as a particular bit error rate (BER). If the error threshold is satisfied, the data storage device may “tag” the block for a second stage of the adaptive write process. In connection with the second stage, data written to the block may be programmed using a modified programming signal. For example, data may be programmed to the block using an increased number of programming pulses and/or using a lower programming voltage (e.g., by decreasing pulse “height”). The modified programming signal may “tighten” distributions that represent data programmed at storage elements of the block (e.g., by reducing “tail” regions of the distributions and by increasing heights of the distributions).

In an illustrative 3D memory configuration, “middle” word lines of the block may be programmed differently than bottom word lines (word lines nearer to the substrate) and top word lines (word lines farther from the substrate). For example, because of variation of a vertical bit line (or other structure) extending through the word lines of the block, the middle word lines may be more reliable than the bottom word lines and the top word lines. Thus, programming signals used to program data to the bottom word lines and the top word lines may include fewer programming pulses and/or greater pulse height as compared to programming signals used to program data to the middle word lines (e.g., in order to “tighten” distributions at the bottom word lines and the top word lines more than distributions at the middle word lines). By tightening the distributions, fewer data errors may occur during reading of the data (because separation between the distributions has increased) as compared to reading data programmed using an unmodified programming signal.

After the second stage of the adaptive write process, if the error rate associated with the block satisfies the error threshold (or another error threshold), data may be programmed to the block using a third stage of the adaptive write process. For example, as the block undergoes more program/erase cycles, the error rate may increase. During the third stage, one or more word lines of the block may be selected for a “downgrade” that reduces a number of bits per cell stored at the one or more word lines. For example, a configuration of a word line may be changed from triple-level-cell (TLC) to multi-level-cell (MLC) or from MLC to single-level-cell (SLC). In an illustrative 3D memory configuration, middle word lines of the block are selected for a TLC configuration and bottom word lines and top word lines of the block are selected for MLC and/or SLC configurations.

The adaptive write process may include one or more additional stages to compensate for additional error rate increases during operation of the data storage device. For example, a downgraded word line of the block having an MLC configuration may be selected for programming using a modified programming signal during a fourth stage of the adaptive write process. As another example, the downgraded MLC word line may be reconfigured as an SLC word line (e.g., during a fifth stage) and/or may be selected for programming using a modified programming signal (e.g., during a sixth stage).

The adaptive write process may enable a tradeoff between programming time and error rate that changes during the lifetime of the data storage device. For example, during beginning-of-life (BoL) of the data storage device (when the data storage device is “fresh”), a programming signal may include fewer programming pulses and greater pulse height and/or a number of bits-per-cell may be greater as compared to middle-of-life (MoL) and end-of-life (EoL) stages of the data storage device. During MoL and EoL stages, the programming signal and/or the number of bits-per-cell may be changed to reduce data errors and data corruption. As a result, programming time during BoL is reduced (to improve performance), and error correction during MoL and/or EoL may be enhanced.

### BRIEF DESCRIPTION OF THE DRAWINGS

FIG. 1 is a block diagram of a particular illustrative embodiment of a system that includes a data storage device that may be configured to perform an adaptive write process;

FIG. 2 is a diagram of an illustrative embodiment of a portion of a memory die that may be included in the data storage device of FIG. 1;

FIG. 3 is a diagram of another illustrative embodiment of a portion of a memory die that may be included in the data storage device of FIG. 1; and

FIG. 4 is a flow diagram of an illustrative embodiment of a method of operation of the data storage device of FIG. 1.

### DETAILED DESCRIPTION

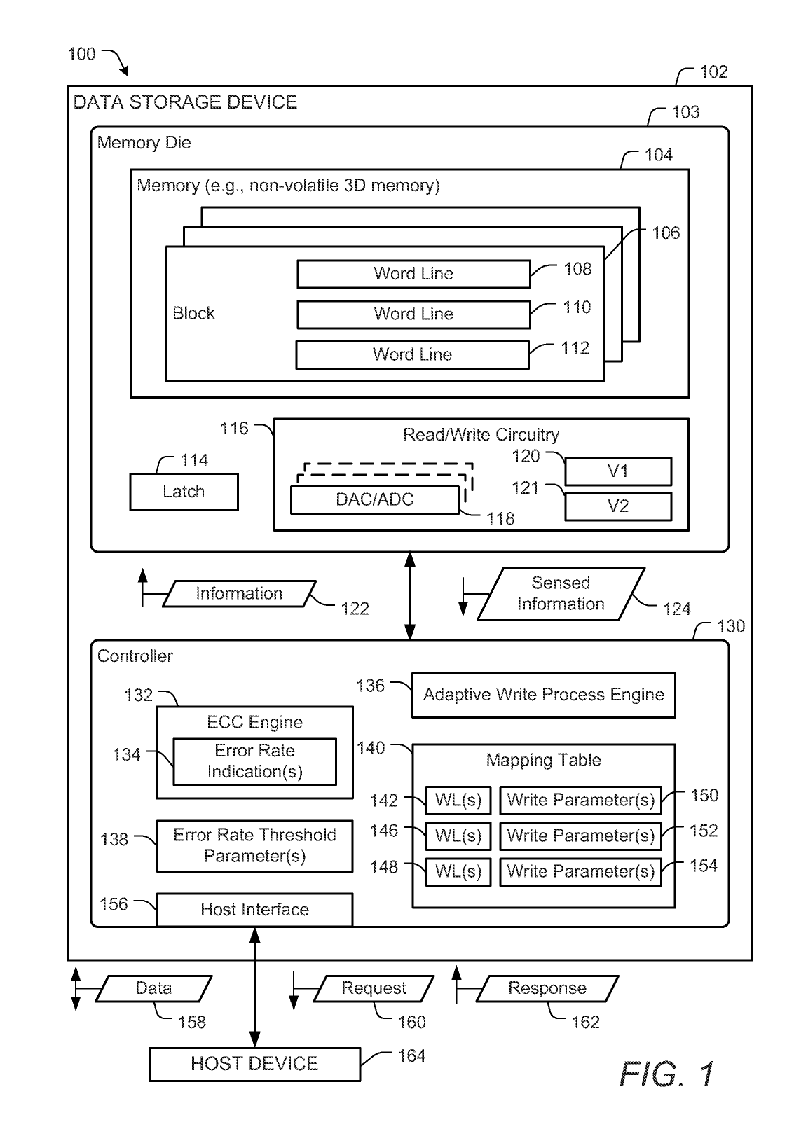

Referring to FIG. 1, an illustrative example of a system is depicted and generally designated 100. The system 100 includes a data storage device 102 and a host device 164. The data storage device 102 and the host device 164 may be operationally coupled via a connection, such as a bus or a wireless connection. The data storage device 102 may be embedded within the host device 164, such as in accordance with a Joint Electron Devices Engineering Council (JEDEC) Solid State Technology Association Universal Flash Storage (UFS) configuration. Alternatively, the data storage device 102 may be removable from the host device 164 (i.e., “removably” coupled to the host device 164). As an example, the data storage device 102 may be removably coupled to the host device 164 in accordance with a removable universal serial bus (USB) configuration.

In some implementations, the data storage device 102 may include a solid state drive (SSD), which may function as an embedded storage drive (e.g., a mobile embedded storage drive), an enterprise storage drive (ESD), a client storage device, or a cloud storage drive, as illustrative, non-limiting examples. In some implementations, the data storage device 102 may be coupled to the host device 164 via a communication network. For example, the data storage device 102 may be a network-attached storage (NAS) device or a component (e.g., an SSD component) of a data center storage system, an enterprise storage system, or a storage area network, as illustrative examples.

The data storage device 102 may include a memory die 103 and a controller 130. The memory die 103 and the controller 130 may be coupled via one or more buses, one or more interfaces, and/or another structure. An interface may be wired (e.g., a bus structure) or wireless (e.g., a wireless communication interface). Although FIG. 1 depicts a single memory die (the memory die 103) for convenience, it should be appreciated that the data storage device 102 may include another number of memory dies corresponding to the memory die 103 (e.g., two memory dies, eight memory dies, or another number of memory dies). Further, although FIG. 1 illustrates that the data storage device 102 includes the controller 130, in other implementations the memory die 103 may be directly coupled to the host device 164 (e.g., the host device 164 may include a controller or other device that accesses the memory die 103).

The memory die 103 includes a memory 104, such as a non-volatile memory. For example, the memory 104 may include a flash memory, such as a NAND flash memory, or a resistive memory, such as a resistive random access memory (ReRAM), as illustrative examples. The memory 104 may have a three-dimensional (3D) memory configuration. As an example, the memory 104 may have a 3D vertical bit line (VBL) configuration. In a particular implementation, the memory 104 is a non-volatile memory having a 3D memory configuration that is monolithically formed in one or more physical levels of arrays of memory cells having an active area disposed above a silicon substrate. Alternatively, the memory 104 may have another configuration, such as a two-dimensional (2D) memory configuration or a non-monolithic 3D memory configuration (e.g., a stacked die 3D memory configuration).

The memory 104 may include one or more regions of storage elements (also referred to herein as memory cells). An example of a region of storage elements is an erase group (or “block”) of storage elements. A block may include a plurality of bit lines and word lines connecting the storage elements. To illustrate, the memory 104 may include representative block 106. Each storage element of the block 106 may be programmable to a state (e.g., a threshold voltage in a flash configuration or a resistive state in a resistive memory configuration) that indicates one or more bit values. Although FIG. 1 depicts three blocks for illustration purposes, it should be appreciated that the memory 104 may include any number of blocks that is suitable for the particular application.

Each block of the memory 104 may include one or more word lines of storage elements. To illustrate, the block 106 may include a word line 108, a word line 110, and a word line 112. In a particular example, the word line 112 is a “bottom” word line that is nearer to a substrate of the memory 104 than other word lines of the block 106. In this example, the word line 108 may be a “top” word line that is father from the substrate than other word lines of the block 106. The word line 110 may be a “middle” word line that is located between the word lines 108, 112. Although FIG. 1 depicts three word lines for illustration purposes, it should be appreciated that a block may include any number of word lines that is suitable for the particular application (e.g., one thousand word lines, or another number of word lines).

The memory die 103 may further include one or more latches (e.g., one or more data latches and/or one or more control latches). For example, the memory die 103 may include a latch 114. The latch 114 may correspond to a data latch that is configured to receive information from the controller 130 for write operations to the memory 104. The latch 114 may have a particular storage size or capacity, which may correspond to a storage size of each word line of the memory 104. It is noted that the memory die 103 may include more than one latch. For example, in an MLC configuration, the memory die 103 may include two latches (e.g., for a two-bit-per-cell implementation) or three latches (e.g., for a three-bit-per-cell implementation), as illustrative examples. In some configurations, a number of latches of the memory die 103 may be greater than or less than a number of bits stored per cell (e.g., four latches in connection with a three-bit-per-cell implementation, as an illustrative example). The latch 114 may include volatile storage elements, such as volatile random access memory (RAM) storage elements.

FIG. 1 also illustrates that the memory die 103 may further include read/write circuitry 116. The read/write circuitry 116 may be coupled to the latch 114. The read/write circuitry 116 may include one or more digital-to-analog converters (DACs) and one or more analog-to-digital (ADCs), such as a DAC/ADC 118. In certain implementations, the read/write circuitry 116 may include multiple DACs and multiple ADCs (e.g., corresponding to stages of an adaptive write process implemented by the data storage device 102). For example, the multiple DACs and multiple ADCs may include a first DAC/ADC (e.g., the DAC/ADC 118) used for three-bit-per-cell write operations, a second DAC/ADC used for two-bit-per-cell write operations, and a third DAC/ADC used for one-bit-per-cell write operations. In other implementations, the read/write circuitry 116 may include a single DAC and a single ADC that is used in connection with each stage of an adaptive write process. The latch 114 and the read/write circuitry 116 are associated with operation of storage elements of the memory 104 (e.g., read and write operations to storage elements of the memory 104).

The controller 130 may include an error correcting code (ECC) engine 132, an adaptive write process engine 136, and a host interface 156. The controller 130 may be coupled to the host device 164 via the host interface 156.

The controller 130 is configured to receive data and instructions from the host device 164 and to send data to the host device 164. For example, the controller 130 may receive data from the host device 164 via the host interface 156 and may send data to the host device 164 via the host interface 156.

The controller 130 is configured to send data and commands to the memory 104 and to receive data from the memory 104. For example, the controller 130 is configured to send data and a write command to cause the memory 104 to store the data to a specified address of the memory 104. The write command may specify a physical address of a portion of the memory 104 that is to store the data. The controller 130 is configured to send a read command to the memory 104 to access data from a specified address of the memory 104. The read command may specify the physical address of a portion of the memory 104.

The ECC engine 132 may be configured to receive data and to generate one or more ECC codewords based on the data. The ECC engine 132 may include a Hamming encoder, a Reed-Solomon (RS) encoder, a Bose-Chaudhuri-Hocquenghem (BCH) encoder, a low-density parity check (LDPC) encoder, a turbo encoder, an encoder configured to encode data according to one or more other ECC schemes, or a combination thereof. The ECC engine 132 may be configured to decode data accessed from the memory 104. For example, the ECC engine 132 may be configured to decode data accessed from the memory 104 to detect and correct one or more errors that may be present in the data, up to an error correcting capacity of the particular ECC scheme. The ECC engine 132 may include a Hamming decoder, an RS decoder, a BCH decoder, an LDPC decoder, a turbo decoder, a decoder configured to decode data according to one or more other ECC schemes, or a combination thereof.

The host device 164 may correspond to a mobile telephone, a computer (e.g., a laptop, a tablet, or a notebook computer), a music player, a video player, a gaming device or console, an electronic book reader, a personal digital assistant (PDA), a portable navigation device, another electronic device, or a combination thereof. The host device 164 may communicate via a host controller, which may enable the host device 164 to communicate with the data storage device 102. The host device 164 may operate in compliance with a JEDEC Solid State Technology Association industry specification, such as an embedded MultiMedia Card (eMMC) specification or a Universal Flash Storage (UFS) Host Controller Interface specification. The host device 164 may operate in compliance with one or more other specifications, such as a Secure Digital (SD) Host Controller specification as an illustrative example. Alternatively, the host device 164 may communicate with the data storage device 102 in accordance with another communication protocol. In some implementations, the data storage device 102 may be a component (e.g., an SSD component) of a network accessible data storage system, such as an enterprise data system, a network-attached storage system, or a cloud data storage system, as illustrative examples.

During operation, the controller 130 may receive data 158 and a request for write access to the memory 104 from the host device 164. The controller 130 may input the data 158 to the ECC engine 132. The ECC engine 132 may encode the data 158 to generate information 122 (e.g., one or more ECC codewords). The controller 130 may send the information 122 to the memory die 103 for storage at the memory 104 (e.g., by storing the information 122 to the latch 114). For example, the memory die 103 may cause the read/write circuitry 116 to store the information 122 at the block 106 using a programming signal 120 (“V1”), such as at one or more of the word lines 108, 110, and 112.

Depending on the particular implementation, the read/write circuitry 116 may be configurable to write the information 122 to the memory 104 using a multiple-bit-per-cell technique or using a single-bit-per-cell technique. Examples of multiple-bit-per-cell techniques include a triple-level cell (TLC) technique (also referred to as three-bits-per-cell or “X3”) and a multi-level cell (MLC) technique (also referred to as two-bits-per-cell or “X2). A single-bit-per-cell technique is also referred to as a single-cell-cell (SLC) technique (“X1”).

In a particular embodiment, the read/write circuitry 116 is responsive to an indication sent by the adaptive write process engine 136 that specifies a number of bits-per-cell associated with the information 122. For example, the controller 130 may issue a “batch” write command to the memory die 103 that includes the information 122, control information (e.g., a write opcode and/or a physical address of a storage destination of the information 122), and the indication from the adaptive write process engine 136. In a particular embodiment, the adaptive write process engine 136 may “default” to a first stage of an adaptive write process. The first stage of the adaptive write process may be associated with a particular number of bits-per-cell, such as a greatest number of bits-per-cell to be used at the memory 104 (based on the particular implementation) during a beginning-of-life (BoL) stage of the data storage device 102. In an illustrative embodiment, the greatest number of bits-per-cell is three. In other cases, the greatest number of bits-per-cell may be another number (e.g., one, two, four, five, or six, as illustrative examples).

Based on the indication received from the adaptive write process engine 136, the read/write circuitry 116 may select a number of bits-per-cell for writing the information 122 to the memory 104. For example, the indication may specify three bits-per-cell, and the read/write circuitry 116 may cause the DAC/ADC 118 to perform a digital-to-analog conversion process using the information 122. The digital-to-analog conversion process may convert bits of the information 122 to an analog signal having multiple voltage levels (e.g., eight voltage levels in the case of three bits-per-cell) that represent the bits of the information 122.

The read/write circuitry 116 may program storage elements of the memory 104 (e.g., to the block 106, such as at one or more of the word lines 108, 110, and 112) to program the information 122 to the memory 104 based on the analog signal. For example, the programming signal 120 may be applied to the memory 104 to program storage elements of the memory 104. The programming signal 120 may include a particular number of pulses each having a particular voltage (or pulse “height,” also referred to as step size). The particular number of pulses and/or the particular voltage may be “default” values that are applied during a first stage of the adaptive write process, such as during BoL of the data storage device 102. By applying the programming signal 120 to storage elements of the memory 104, states of the storage elements may indicate bits of the information 122.

The controller 130 may receive a request for read access from the host device 164 to access the data 158. In response to receiving the request for access to the data 158, the controller 130 may send a command to the memory die 103 specifying an address associated with the information 122. In response to the command, the memory die 103 may cause the read/write circuitry 116 to sense the information 122 to generate a signal (e.g., an analog signal representing multiple bits). The DAC/ADC 118 may perform an analog-to-digital conversion process to generate a set of bits based on the analog signal, such as by digitizing the analog signal to generate sensed information 124. In some circumstances, one or more values of the sensed information 124 may differ from the values of the information 122, such as due to read errors or other errors. As the memory 104 is subject to more program/erase cycles, information sensed from the memory 104 may include a greater number of errors.

The memory die 103 may provide the sensed information 124 to the controller 130 (e.g., via the latch 114), and the controller 130 may input the sensed information 124 to the ECC engine 132. The ECC engine 132 may decode the sensed information 124 (e.g., by correcting one or more data errors) to generate the data 158. The controller 130 may provide the data 158 to the host device 164 via the host interface 156.

In a particular embodiment, the controller 130 is configured to determine one or more indications 134 of error rates associated with information. For example, the ECC engine 132 may determine a first error rate indication of the one or more indications 134 while decoding the sensed information 124. The first error rate indication may identify a first error rate associated with the sensed information 124, such as a first number of errors corrected during decoding of the sensed information 124 and/or a first bit error rate (BER) associated with the sensed information 124.

In response to determining the first error rate indication, the controller 130 may input the first error rate indication to the adaptive write process engine 136. The adaptive write process engine 136 may be configured to compare the first error rate indication with one or more error rate threshold parameters 138 that indicate one or more error rate thresholds. For example, the one or more error rate threshold parameters 138 may include a first parameter that indicates a first error rate threshold, such as a first threshold number of errors and/or a first threshold BER.

The adaptive write process engine 136 may be configured to compare the first error rate with the first error rate threshold to determine whether the first error rate satisfies the first error rate threshold. If the first error rate fails to satisfy (e.g., is less than) the first error rate threshold, the adaptive write process engine 136 may continue using the first stage of the adaptive write process. If the first error rate satisfies (e.g., is greater than or equal to) the first error rate threshold, the adaptive write process engine 136 may initiate a second stage of the adaptive write process. For convenience of description, stages of the adaptive write process are described on a “per block” basis (e.g., as being specific to the block 106). In other implementations, stages of the adaptive write process may be performed on a different basis, such as a word line basis, a “global” basis, or another basis that uses other regions of the memory 104.

In an illustrative implementation, the adaptive write process engine 136 is configured to initiate the second stage of the adaptive write process by adjusting one or more write parameters associated with the block 106, such as by adjusting a programming signal used to program information at the block 106. For example, an adjusted programming signal 121 (“V2”) may include an increased number of pulses relative to the programming signal 120 and/or a decreased voltage relative to the programming signal 120 (e.g., to “tighten” distributions of states, such as an erase state, an “A” state, a “B” state, and a “C” state). The adjusted programming signal 121 may be used to program subsequent information (e.g., without rewriting information that is already stored at the block 106). In other implementations, the block 106 can be erased, and information (e.g., the information 122) can be re-programmed at the block 106 using the adjusted programming signal 121.

In a particular embodiment, the controller 130 is configured to update a mapping table 140 to indicate one or more write parameters associated with the block 106. For example, the mapping table 140 may indicate write parameters 150, 152, and 154 associated with the block 106. Each of the write parameters 150, 152, and 154 may indicate a characteristic of a programming signal used to write information to the block 106 (e.g., a number of programming pulses and a voltage of the programming signal) and/or a number of bits-per-cell of information written to the block 106 (or to a portion of the block 106). For example, each of the write parameters 150, 152, 154 may specify either the programming signal 120 or the adjusted programming signal 121.

In an illustrative 3D memory configuration, “middle” word lines of the block 106 may be programmed differently than bottom word lines (word lines nearer to the substrate) and top word lines (word lines farther from the substrate). For example, because of variation of a vertical bit line (or other structure) extending through the word lines of the block 106, the middle word lines may be more reliable than the bottom word lines and the top word lines.

In a particular embodiment, the write parameters 150 indicate a first set of one or more write parameters for a first group 142 of word lines of the block 106 (e.g., including the word line 108), the write parameters 152 indicate a second set of one or more write parameters for a second group 146 of word lines of the block 106 (e.g., including the word line 110), and the write parameters 154 indicate a third set of parameters for a third group 148 of word lines of the block 106 (e.g., including the word line 112). In this example, the word lines of the first group 142 have a greater distance from a substrate of the memory die 103 than the word lines of the second group 146, and the word lines of the second group 146 have a greater distance from the substrate than the word lines of the third group 148.

In a particular embodiment, programming signals used to program information to word lines of the groups 142, 148 may include fewer programming pulses and/or greater pulse height as compared to programming signals used to program information to word lines of the second group 146 (e.g., in order to “tighten” distributions at the bottom word lines and the top word lines more than distributions at the middle word lines). For example, the programming signal 120 may be applied to word lines of the groups 142, 148 (e.g., to “tighten” distributions to reduce errors for less reliable word lines), and the adjusted programming signal 121 may be applied to word lines of the second group 146 (e.g., to reduce programming time during write operations to more reliable word lines). By tightening the distributions (e.g., at less reliable word lines), fewer data errors may occur during reading of the data (because separation between the distributions has increased) as compared to data programmed using an unadjusted programming signal.

In some circumstances, the adaptive write process engine 136 may be configured to initiate a third stage of the adaptive write process. To illustrate, during the second stage, the ECC engine 132 may determine a second error rate while decoding information sensed from the block 106 (e.g., a number of errors or a BER). In this example, the one or more indications may include a second error rate indication.

In response to determining the second error rate indication, the controller 130 may input the second error rate indication to the adaptive write process engine 136. The adaptive write process engine 136 may be configured to compare the second error rate indication with the one or more error rate threshold parameters 138 that indicate one or more error rate thresholds, such as the first error rate threshold described above. In this case, the adaptive write process engine 136 may be configured to enforce a common error ceiling (the first error rate threshold) during the operating lifetime of the data storage device 102 (e.g., BoL, MoL, and EoL). In other cases, the one or more error rate threshold parameters 138 may include a second parameter that indicates a second error rate threshold, such as a second threshold number of errors and/or a second threshold BER. The second error rate threshold may be different than (e.g., greater than) the first error rate threshold.

The adaptive write process engine 136 may be configured to compare the first error rate with the first error rate threshold (or the second error rate threshold). If the first error rate fails to satisfy (e.g., is less than) the first error rate threshold (or the second error rate threshold), the adaptive write process engine 136 may continue to operate based on the second stage of the adaptive write process. If the first error rate satisfies (e.g., is greater than or equal to) the first error rate threshold (or the second error rate threshold), the adaptive write process engine 136 may initiate a third stage of the adaptive write process.

In an illustrative implementation, the adaptive write process engine 136 is configured to initiate the third stage of the adaptive write process by changing a configuration of a word line of the block 106. The configuration may include a number of bits-per-cell of the word line. To illustrate, the configuration may be changed (e.g., “downgraded”) from a three-bit-per-cell configuration to a two-bit-per-cell configuration. The word line may correspond to any of the word lines 108, 110, and 112, as illustrative examples. The adaptive write process engine 136 may be configured to update the mapping table 140 in response to changing the configuration of the word line (e.g., by updating one or more of the write parameters 150, 152, and 154).

In a particular embodiment, the third stage may include “sub-stages” during which configuration of the word lines 108, 110, and 112 are adjusted independently. For example, in an illustrative implementation, a number of bits-per-cell of top word lines and/or bottom word lines of the block 106 may be adjusted during first and/or second sub-stages prior to adjusting a number of bits-per-cell of middle word lines of the block 106 during a third sub-stage. During the first and/or second sub-stages, a number of bits-per-cell that may be stored at word lines of the groups 142, 148 may be less than a number of bits-per-cell stored at word lines of the second group 146 (e.g., two-bits-per-cell for the groups 142, 148 instead of three-bits-per-cell for the second group 146, as an illustrative example). During the third sub-stage, word lines of the second group 146 may be downgraded (e.g., from three-bits-per-cell to two-bits-per-cell). Reducing the number of bits-per-cell associated with the groups 142, 148 may compensate for reduced performance of “top” and “bottom” word lines of the memory 104. In at least one implementation, the read/write circuitry 116 includes multiple DACs/ADCs associated with different numbers of bits-per-cell, and the write parameters 150, 152, and 154 each specify one of the DACs/ADCs associated with a corresponding one of the groups 142, 146, and 148.

Depending on the particular implementation, write operations of the third stage may be performed using the programming signal 120 (instead of the adjusted programming signal 121). For example, after “downgrading” a word line, one or more subsequent write operations to the word line may be performed during the third stage using the programming signal 120 (instead of the adjusted programming signal 121) in order to increase speed of the write operations (while also achieving improved error rates as a result of “downgrading” the word line).

The adaptive write process may include one or more additional stages. For example, the adaptive write process engine 136 may continue to track error rates associated with the block 106 (e.g., using error rates determined during decoding of information sensed from the block 106). If the adaptive write process engine 136 determines that an error rate satisfies an error rate threshold (e.g., the first error rate threshold, the second error rate threshold, or another error rate threshold), the adaptive write process engine 136 may initiate one or more additional stages of the adaptive write process (e.g., a fourth stage, a fifth stage, and/or a six stage).

In a particular embodiment, the adaptive write process engine 136 is configured to re-adjust any of the write parameters 150, 152, and 154 to initiate a fourth stage of the adaptive write process. For example, during the fourth stage, the adjusted programming signal 121 may be applied to a “downgraded” word line during write operations to the downgraded word line. As an illustrative example, during the fourth stage, the adjusted programming signal 121 may be used to program information to a word line downgraded (during the third stage) from three-bits-per-cell to two-bits-per-cell.

To initiate the fifth stage, the adaptive write process engine 136 may be configured to change the configuration of the word line from the two-bit-per-cell configuration to a one-bit-per-cell configuration. The fifth stage may include “sub-stages” (e.g., as described with reference to the third stage). For example, in an illustrative implementation, a number of bits-per-cell of top word lines and/or bottom word lines of the block 106 may be adjusted during first and/or second sub-stages prior to adjusting a number of bits-per-cell of middle word lines of the block 106 during a third sub-stage. During the first and second sub-stages, a number of bits-per-cell may be stored at word lines of the groups 142, 148 may be less than a number of bits-per-cell stored at word lines of the second group 146 (e.g., one-bit-per-cell for the groups 142, 148 instead of for the second group 146, as an illustrative example). During the third sub-stage, word lines of the second group 146 may be downgraded (e.g., from two-bits-per-cell to one-bit-per-cell). During the fifth stage, the programming signal 120 may be used to write information to the word line.

To initiate the sixth stage, the adaptive write process engine 136 may program information to word lines downgraded during the fifth stage using the adjusted programming signal 121. Thus, one or more one-bit-per-cell word lines of the block 106 may be programmed using the adjusted programming signal 121 during the sixth stage.

In an illustrative implementation, the adaptive write process engine 136 is configured to send a request 160 to the host device 164. The request 160 may indicate that the host device 164 is to specify the one or more write parameters to be adjusted to initiate a particular stage of the adaptive write process. For example, the host device 164 may prompt a user to indicate which parameter is to be adjusted in connection with the adaptive write process. To illustrate, adjusting a programming signal (e.g., using the adjusted programming signal 121) may increase latency at the data storage device 102 by increasing duration of write operations (without reducing available storage size of the memory 104). Changing a number of bits-per-cell associated with the memory 104 may reduce available storage size (without increased latency). Thus, the user may be prompted to select one of multiple options, such as by prompting the user to indicate whether write operation speed should be reduced or available storage size should be reduced. In this example, the adaptive write process engine 136 may receive a response 162 from the host device 164. The response 162 may indicate the one or more write parameters to be adjusted. Thus, it is noted that although an example adaptive write process is described above for convenience, one or more stages of the adaptive write process may differ from the example sequence (e.g., based on user input received via the response 162).

In connection with the described embodiments, an apparatus (e.g., the data storage device 102) includes a memory die (e.g., the memory die 103), and the memory die includes a memory (e.g., the memory 104) having a three-dimensional (3D) memory configuration. The apparatus further includes a controller (e.g., the controller 130) coupled to the memory die. The controller is configured to initiate a write operation to write information (e.g., the information 122) to a region (e.g., a block, such as the block 106) of the memory during a first stage of an adaptive write process. The controller is further configured to initiate a sense operation to sense the information to generate sensed information (e.g., the sensed information 124). The controller is further configured to initiate a second stage of the adaptive write process in response to an error rate associated with the sensed information satisfying an error threshold. For example, the error rate may correspond to one of indications 134, and the error threshold may correspond to one of the error rate threshold parameters 138.

FIG. 1 illustrates aspects of an adaptive write process that may enable a tradeoff between programming time and error rate that adapts during the lifetime of the data storage device. For example, during BoL of the data storage device 102 (when the data storage device 102 is “fresh”), a programming signal may include fewer programming pulses and greater pulse height and/or a number of bits-per-cell may be greater as compared to MoL and EoL stages of the data storage device 102. During MoL and EoL stages, the programming signal and/or the number of bits-per-cell may be changed to reduce data errors and data corruption. As a result, programming time during BoL is reduced (to improve performance), and error correction during MoL and/or EoL may be enhanced (e.g., to prolong useful life of the data storage device 102).

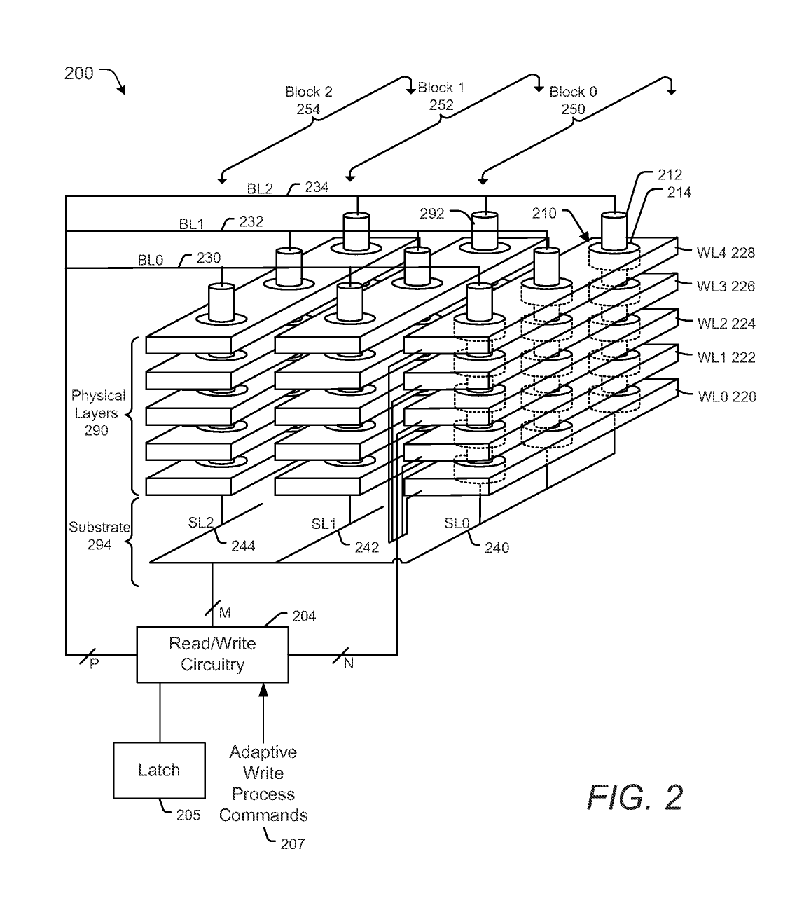

FIG. 2 illustrates a portion of a memory die 200 having a NAND flash configuration. The memory die 200 may be included in the data storage device 102 of FIG. 1. For example, the memory die 200 may correspond to the memory die 103 of FIG. 1. The memory die 200 may be coupled to the controller 130 of FIG. 1.

The memory die 200 may include read/write circuitry 204 and one or more latches (e.g., a latch 205). The read/write circuitry 204 may correspond to the read/write circuitry 116 of FIG. 1, and the latch 205 may correspond to the latch 114 of FIG. 1. The read/write circuitry 204 may be responsive to adaptive write process commands 207 issued by the adaptive write process engine 136 of FIG. 1. The adaptive write process commands 207 may initiate stages of the adaptive write process described with reference to FIG. 1 (e.g., by specifying the programming signal 120 or the adjusted programming signal 121 for a write operation and/or by specifying a number of bits-per-cell for a write operation, such as X3, X2, or X1). In a particular embodiment, the adaptive write process engine 136 and the read/write circuitry 204 are coupled via a dedicated bus that is reserved for the adaptive write process commands 207. In another implementation, the adaptive write process commands 207 are sent via a bus used for data and other information.

The memory die 200 includes multiple physical layers, such as a group of physical layers 290. The multiple physical layers are monolithically formed above a substrate 294, such as a silicon substrate. Storage elements (e.g., memory cells), such as a representative memory cell 210, are arranged in arrays in the physical layers.

The representative memory cell 210 includes a charge trap structure 214 between a word line/control gate (WL4) 228 and a conductive channel 212. Charge may be injected into or drained from the charge trap structure 214 via biasing of the conductive channel 212 relative to the word line 228. For example, the charge trap structure 214 may include silicon nitride and may be separated from the word line 228 and the conductive channel 212 by a gate dielectric, such as silicon oxide. An amount of charge in the charge trap structure 214 affects an amount of current through the conductive channel 212 during a read operation of the memory cell 210 and indicates one or more bit values that are stored in the memory cell 210.

The memory die 200 includes multiple erase blocks, including a first block (block 0) 250, a second block (block 1) 252, and a third block (block 2) 254. Each block 250-254 includes a “vertical slice” of the physical layers 290 that includes a stack of word lines, illustrated as a first word line (WL0) 220, a second word line (WL1) 222, a third word line (WL2) 224, a fourth word line (WL3) 226, and a fifth word line (WL4) 228. Multiple conductive channels (having a substantially vertical orientation with respect to FIG. 2) extend through the stack of word lines. Each conductive channel is coupled to a storage element in each word line 220-228, forming a NAND string of storage elements. FIG. 2 illustrates three blocks 250-254, five word lines 220-228 in each block, and three conductive channels in each block for clarity of illustration. However, the memory die 200 may have more than three blocks, more than five word lines per block, and more than three conductive channels per block.

The read/write circuitry 204 is coupled to the conductive channels via multiple conductive lines, illustrated as a first bit line (BL0) 230, a second bit line (BL1) 232, and a third bit line (BL2) 234 at a “top” end of the conducive channels (e.g., farther from the substrate 294). The read/write circuitry 204 is also coupled to the conductive channels via multiple source lines, such as via a first source line (SL0) 240, a second source line (SL1) 242, and a third source line (SL2) 244 at a “bottom” end of the conductive channels (e.g., nearer to or within the substrate 294). The read/write circuitry 204 is illustrated as coupled to the bit lines 230-234 via “P” control lines, coupled to the source lines 240-244 via “M” control lines, and coupled to the word lines 220-228 via “N” control lines. Each of P, M, and N may have a positive integer value based on the specific configuration of the memory die 200. In the illustrative example of FIG. 2, P=3, M=3, and N=5.

In a particular embodiment, each of the bit lines and each of the source lines may be coupled to the same end (e.g., the top end or the bottom end) of different conductive channels. For example, a particular bit line may be coupled to the top of a conductive channel 292 and a particular source line may be coupled to the top of the conductive channel 212. The bottom of the conductive channel 292 may be coupled (e.g., electrically coupled) to the bottom of the conductive channel 212. Accordingly, the conductive channel 292 and the conductive channel 212 may be coupled in series and may be coupled to the particular bit line and the particular source line.

During a write operation, the controller 130 of FIG. 1 may receive a request from the host device 164 of FIG. 1. The request may include data (e.g., the data 158) to be written at storage elements of the memory die 200. The controller 130 may send a command to the memory die 200 to cause the memory die 200 to initiate the write operation. For example, the controller 130 may send a write opcode and a physical address to the read/write circuitry 204 and data to the latch 205. The adaptive write process engine 136 may send a particular command of the adaptive write process commands 207 to the read/write circuitry 204.

The read/write circuitry 204 may be configured to access the data in the latch 205 and to program the data to storage elements of the memory die 200 based on one or more write parameters indicated by the particular command. For example, the read/write circuitry 204 may be configured to apply selection signals to control lines coupled to the word lines 220-228, the bit lines 230-234, and the source lines 240-242 to cause a programming voltage (e.g., a voltage pulse or series of voltage pulses) to be applied across one or more selected storage elements of the selected word line (e.g., the fourth word line 228, as an illustrative example). The programming voltage may correspond to either the programming signal 120 or the adjusted programming signal 121.

During a read operation, the controller 130 of FIG. 1 may receive a request from a host device, such as the host device 164 of FIG. 1. The controller 130 may cause the read/write circuitry 204 to read bits from particular storage elements of the memory die 200 by applying appropriate signals to the control lines to cause storage elements of a selected word line to be sensed. Accordingly, the memory die 200 may be configured to store and access data, such as by storing the information 122 and by sensing the information 122 to generate the sensed information 124 of FIG. 1.

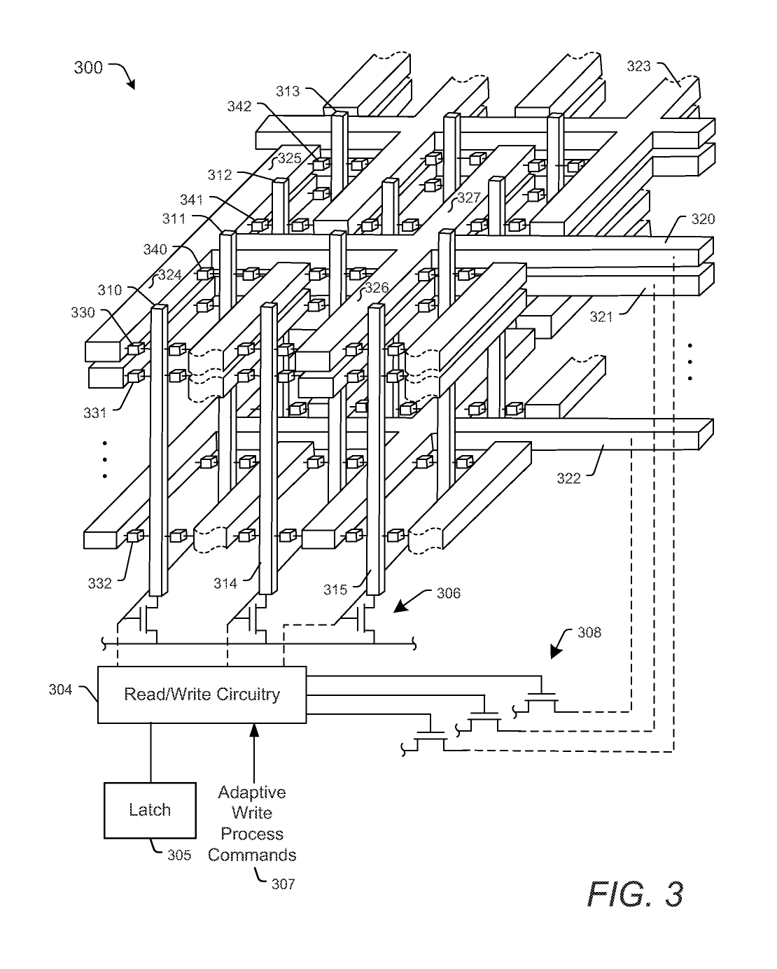

FIG. 3 illustrates a portion of a memory die 300 having a ReRAM configuration. The memory die 300 may be included in the data storage device 102 of FIG. 1. For example, the memory die 300 may correspond to the memory die 103 of FIG. 1. The memory die 300 may be coupled to the controller 130 of FIG. 1 (or to the host device 164 of FIG. 1).

The memory die 300 may include read/write circuitry 304 and one or more latches (e.g., a latch 305). The read/write circuitry 304 may correspond to the read/write circuitry 116 of FIG. 1, and the latch 305 may correspond to the latch 114 of FIG. 1. The read/write circuitry 304 may be responsive to adaptive write process commands 307 issued by the adaptive write process engine 136 of FIG. 1. The adaptive write process commands 307 may initiate stages of the adaptive write process described with reference to FIG. 1 (e.g., by specifying the programming signal 120 or the adjusted programming signal 121 for a write operation and/or by specifying a number of bits-per-cell for a write operation, such as X3, X2, or X1). In a particular embodiment, the adaptive write process engine 136 and the read/write circuitry 304 are coupled via a dedicated bus that is reserved for the adaptive write process commands 307. In another implementation, the adaptive write process commands 307 are sent via a bus used for data and other information.

In the example of FIG. 3, the memory die 300 includes a vertical bit line (VBL) ReRAM with a plurality of conductive lines in physical layers over a substrate (e.g., substantially parallel to a surface of the substrate), such as representative word lines 320, 321, 322, and 323 (only a portion of which is shown in FIG. 3) and a plurality of vertical conductive lines through the physical layers, such as representative bit lines 310, 311, 312, and 313. The word line 322 may include or correspond to a first group of physical layers, and the word lines 320, 321 may include or correspond to a second group of physical layers.

The memory die 300 also includes a plurality of resistance-based storage elements (e.g., memory cells), such as representative storage elements 330, 331, 332, 340, 341, and 342. Each of the storage elements 330, 331, 332, 340, 341, and 342 is coupled to (or is associated with) a bit line and a word line in arrays of memory cells in multiple physical layers over the substrate (e.g., a silicon substrate).

In the example of FIG. 3, each word line includes a plurality of fingers. To illustrate, the word line 320 includes fingers 324, 325, 326, and 327. Each finger may be coupled to more than one bit line. For example, the finger 324 of the word line 320 is coupled to the bit line 310 via the storage element 330 at a first end of the finger 324, and the finger 324 is further coupled to the bit line 311 via the storage element 340 at a second end of the finger 324.

In the example of FIG. 3, each bit line may be coupled to more than one word line. To illustrate, the bit line 310 is coupled to the word line 320 via the storage element 330, and the bit line 310 is further coupled to the word line 322 via the storage element 332.

During a write operation, the controller 130 of FIG. 1 may receive data (e.g., the data 158 of FIG. 1) from a host device, such as the host device 164 of FIG. 1. The controller 130 may send a command to the memory die 300 to cause the memory die 300 to initiate the write operation. The controller 130 may send data (e.g., the information 122) to the memory die 300 to be written to storage elements of the memory die 300. For example, the controller 130 may latch the data into the latch 305. The adaptive write process engine 136 may issue a particular command of the adaptive write process commands 307 to the read/write circuitry 304 specifying one or more write parameters for the write operation.

The read/write circuitry 304 may be configured to access the data in the latch 305 and to program the data to storage elements corresponding to the destination of the data. For example, the read/write circuitry 304 may apply selection signals to selection control lines coupled to the word line drivers 308 and the bit line drivers 306 to cause a write voltage to be applied across a selected storage element. As an illustrative example, to select the storage element 330, the read/write circuitry 304 may activate the word line drivers 308 and the bit line drivers 306 to drive a programming current (also referred to as a write current) through the storage element 330. To illustrate, a first write current may be used to write a first logical value (e.g., a value corresponding to a high-resistance state) to the storage element 330, and a second write current may be used to write a second logical value (e.g., a value corresponding to a low-resistance state) to the storage element 330. The programming current may be applied by generating a programming voltage across the storage element 330 by applying a first voltage to the bit line 310 and to word lines other than the word line 320 and by applying a second voltage to the word line 320. In a particular embodiment, the first voltage is applied to other bit lines (e.g., the bit lines 314, 315) to reduce leakage current in the memory die 300.

During a read operation, the controller 130 may receive a request from a host device, such as the host device 164 of FIG. 1. The controller 130 may issue a command to the memory die 300 specifying one or more physical addresses of the memory die 300.

The memory die 300 may cause the read/write circuitry 304 to read bits from particular storage elements of the memory die 300, such as by applying selection signals to selection control lines coupled to the word line drivers 308 and the bit line drivers 306 to cause a read voltage to be applied across a selected storage element. For example, to select the storage element 330, the read/write circuitry 304 may activate the word line drivers 308 and the bit line drivers 306 to apply a first voltage (e.g., 0.7 volts (V)) to the bit line 310 and to word lines other than the word line 320. A lower voltage (e.g., 0 V) may be applied to the word line 320. Thus, a read voltage is applied across the storage element 330, and a read current corresponding to the read voltage may be detected at a sense amplifier of the read/write circuitry 304. The read current corresponds (via Ohm's law) to a resistance state of the storage element 330, which corresponds to a logic value stored at the storage element 330. The logic value read from the storage element 330 and other elements read during the read operation may be provided to the controller 130 of FIG. 1 (e.g., via the latch 305).

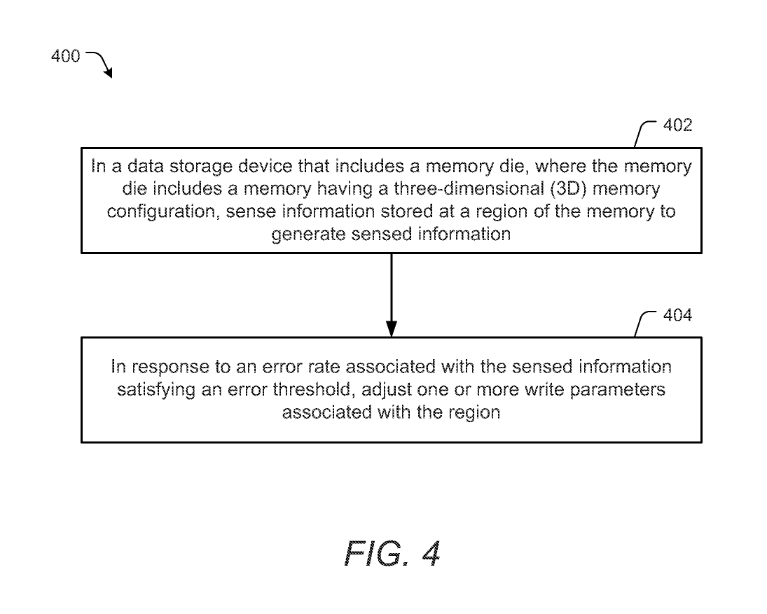

Referring to FIG. 4, an illustrative example of a method is depicted and generally designated 400. The method 400 may be performed at a data storage device (e.g., the data storage device 102) that includes a memory die (e.g., any of the memory dies 103, 200, and 300). The memory die may include a memory (e.g., the memory 104). The memory has a three-dimensional (3D) memory configuration. For example, the 3D memory configuration may be monolithically formed in one or more physical levels of arrays of memory cells having an active area above a silicon substrate (e.g., the substrate 294). The memory die may further include circuitry (e.g., the read/write circuitry 116, the read/write circuitry 204, and/or the read/write circuitry 304) associated with operation of the memory cells.

The method 400 includes sensing information stored at a region of the memory to generate sensed information, at 402. For example, the information 122 may be sensed to generate the sensed information 124. The region may correspond to a block, such as any of the blocks 106, 250, 252, or 252, as illustrative examples. In a NAND flash configuration, a “block” may refer to an erase group of storage elements. In a ReRAM configuration, the region (or “block”) may be a group of storage elements, such as one or more word lines of storage elements (e.g., the word lines 320, 321, 322, and 323), one or more bit lines of storage elements (e.g., the bit lines 310, 311, 312, and 313), and/or one or more fingers of storage elements (e.g., the fingers 324, 325, 326, and 327), as illustrative examples.

The method 400 further includes adjusting one or more write parameters associated with the region in response to an error rate associated with the sensed information satisfying an error threshold, at 404. For example, the error rate may correspond to one of the indications 134, and the error threshold may correspond to one of the error rate threshold parameters 138.

To further illustrate, the one or more write parameters may indicate one or more of a number of pulses of a programming signal or a voltage of one or more of the pulses of the programming signal. In this example, the programming signal may correspond to the adjusted programming signal 121 of FIG. 1. Alternatively or in addition, the one or more write parameters may be specific to groups of word lines based on heights of the word lines relative to a substrate. For example, the one or more write parameters may include a first set of one or more write parameters (e.g., the write parameters 150) for a first group (e.g., the first group 142) of word lines of the region, a second set of one or more write parameters (e.g., the write parameters 152) for a second group (e.g., the second group 146) of word lines of the region, and a third set of write parameters (e.g., the write parameters 154) for a third group (e.g., the third group 148) of word lines of the region.

In this example, the word lines of the first group may have a greater distance from (e.g., height relative to) the substrate of the memory die than the word lines of the second group, and the word lines of the second group may have a greater distance from (e.g., height relative to) the substrate than the word lines of the third group. For example, the word line 108 may have a greater distance from the substrate than the word line 110, and the word line 110 may have a greater distance from the substrate than the word line 108. As another example, the word line 228 may have a greater distance from the substrate than the word line 226, the word line 226 may have a greater distance from the substrate than the word line 224, the word line 224 may have a greater distance from the substrate than the word line 222, and the word line 222 may have a greater distance from the substrate than the word line 220. As an additional example, the word line 320 may have a greater distance from the substrate than the word line 321, and the word line 321 may have a greater distance from the substrate than the word line 322. In other implementations, the one or more write parameters may be associated with each word line of the region (e.g., the one or more write parameters may be assigned to all word lines of a block).

The method 400 may optionally include updating a table to indicate that the region is associated with the one or more adjusted write parameters. For example, the mapping table 140 may be updated to indicate that subsequent write operations to the block 106 (or one or more word lines of the block 106) are to be performed using the adjusted programming signal 121.

The method 400 may optionally include changing (or “downgrading”) a configuration of the region (or a configuration of one or more word lines of the region). To illustrate, a word line of the region (or the entire region) may be changed from a three-bit-per-cell configuration to a two-bit-per-cell configuration after adjusting the one or more write parameters. For example, any of the word lines 108, 110, 112, 220, 222, 224, 226, 228, 320, 321, 322, and 323 may be changed from a three-bit-per-cell configuration to a two-bit-per-cell configuration. In a particular embodiment, the programming signal 120 is used to program information at the word line after “downgrading” the word line (e.g., write operations may “default” to the programming signal 120).

The method 400 may optionally include re-adjusting the one or more write parameters after changing the configuration. For example, a programming signal used to program information to the word line may be changed from the programming signal 120 to the adjusted programming signal 121 while the word line has a two-bits-per-cell configuration.

The method 400 may optionally include changing the configuration from the two-bit-per-cell configuration to a one-bit-per-cell configuration after re-adjusting the one or more write parameters. For example, any of the word lines 108, 110, 112, 220, 222, 224, 226, 228, 320, 321, 322, and 323 may be changed from a three-bit-per-cell configuration to a two-bit-per-cell configuration. In a particular embodiment, the programming signal 120 is used to program information at the word line after “downgrading” the word line (e.g., write operations may “default” to the programming signal 120).

The method 400 may optionally include re-adjusting the one or more write parameters after changing the configuration. For example, a programming signal used to program information to the word line may be changed from the programming signal 120 to the adjusted programming signal 121 while the word line has a one-bit-per-cell configuration.

The method 400 may optionally include sending a request (e.g., the request 160) to a host device (e.g., the host device 164) and receiving a response (e.g., the response 162) from the host device. The response may indicate the one or more write parameters. For example, at any particular stage of an adaptive write process, the adaptive write process engine 136 may send the request 160 to the host device 164 to request the host device 164 to specify which stage of the adaptive write process should be initiated. In a particular embodiment, a user may be prompted to indicate which stage should be initiated, such as by prompting the user to select between faster performance with less storage capacity (e.g., downgrading one or more word lines) or slower performance without loss of storage capacity (e.g., adjusting of a programming signal).

In a particular embodiment, the data storage device further includes a controller coupled to the memory die, such as the controller 130. One or more operations of the method 400 may be performed, initiated, or controlled by the controller 130, such as by the adaptive write process engine 136.

Although the adaptive write process engine 136 and certain other components described herein are illustrated as block components and described in general terms, such components may include one or more microprocessors, state machines, and/or other circuits configured to enable the data storage device 102 (or one or more components thereof) to perform operations described herein. Components described herein may be operationally coupled to one another using one or more nodes, one or more buses (e.g., data buses and/or control buses), one or more other structures, or a combination thereof. One or more components described herein may include one or more physical components, such as hardware controllers, state machines, logic circuits, one or more other structures, or a combination thereof, to enable the data storage device 102 to perform one or more operations described herein. For example, the adaptive write process engine 136 may include one or more hardware components, such as a comparator device to perform comparison operations and/or a state machine configured to store a value that indicates a stage of an adaptive write process.

Alternatively or in addition, one or more aspects of the data storage device 102 may be implemented using a microprocessor or microcontroller programmed (e.g., by executing instructions) to perform operations described herein, such as one or more operations of the method 400 of FIG. 4. One or more operations described with reference to the adaptive write process engine 136 may be implemented using a processor that executes instructions. In a particular embodiment, the data storage device 102 includes a processor executing instructions (e.g., firmware) retrieved from the memory 104. Alternatively or in addition, instructions that are executed by the processor may be retrieved from a separate memory location that is not part of the memory 104, such as at a read-only memory (ROM).

It should be appreciated that one or more operations described herein as being performed by the controller 130 may be performed at the memory 104. As an illustrative example, “in-memory” ECC operations may be performed at the memory die 103 alternatively or in addition to performing such operations at the controller 130.

The data storage device 102 may be attached to or embedded within one or more host devices, such as within a housing of a host communication device (e.g., the host device 164). For example, the data storage device 102 may be integrated within an apparatus such as a mobile telephone, a computer (e.g., a laptop, a tablet, or a notebook computer), a music player, a video player, a gaming device or console, an electronic book reader, a personal digital assistant (PDA), a portable navigation device, or other device that uses internal non-volatile memory. However, in other embodiments, the data storage device 102 may be implemented in a portable device configured to be selectively coupled to one or more external devices, such as the host device 164.

To further illustrate, the data storage device 102 may be configured to be coupled to the host device 164 as embedded memory, such as in connection with an embedded MultiMedia Card (eMMC®) (trademark of JEDEC Solid State Technology Association, Arlington, Va.) configuration, as an illustrative example. The data storage device 102 may correspond to an eMMC device. As another example, the data storage device 102 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof.

The memory 104 may include a three-dimensional (3D) memory, such as a resistive random access memory (ReRAM), a flash memory (e.g., a NAND memory, a NOR memory, a single-level cell (SLC) flash memory, a multi-level cell (MLC) flash memory, a divided bit-line NOR (DINOR) memory, an AND memory, a high capacitive coupling ratio (HiCR) device, an asymmetrical contactless transistor (ACT) device, or another flash memory), an erasable programmable read-only memory (EPROM), an electrically-erasable programmable read-only memory (EEPROM), a read-only memory (ROM), a one-time programmable memory (OTP), or a combination thereof. In a particular embodiment, the data storage device 102 is indirectly coupled to an accessing device (e.g., the host device 164) via a network. For example, the data storage device 102 may be a network-attached storage (NAS) device or a component (e.g., a solid-state drive (SSD) component) of a data center storage system, an enterprise storage system, or a storage area network. Alternatively or in addition, the memory 104 may include another type of memory. The memory 104 may include a semiconductor memory device.

Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure. In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate). As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Alternatively, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this disclosure is not limited to the two dimensional and three dimensional exemplary structures described but cover all relevant memory structures within the spirit and scope of the disclosure as described herein and as understood by one of skill in the art. The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Those of skill in the art will recognize that such modifications are within the scope of the present disclosure.

The above-disclosed subject matter is to be considered illustrative, and not restrictive, and the appended claims are intended to cover all such modifications, enhancements, and other embodiments, that fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
in a data storage device that includes a memory die, wherein the memory die includes a memory having a three-dimensional (3D) memory configuration, performing:
sensing information stored at a region of the memory to generate sensed information; and
in response to an error rate associated with the sensed information satisfying an error threshold, adjusting one or more write parameters associated with the region.

2. The method of claim 1, wherein the one or more write parameters indicate one or more of a number of pulses of a programming signal or a voltage of one or more of the pulses of the programming signal.

3. The method of claim 1, further comprising updating a table to indicate that the region is associated with the one or more adjusted write parameters.

4. The method of claim 1, further comprising, after adjusting the one or more write parameters, changing a configuration of the region or of a word line of the region from a three-bit-per-cell configuration to a two-bit-per-cell configuration.

5. The method of claim 4, further comprising, after changing the configuration of the word line, re-adjusting the one or more write parameters.

6. The method of claim 5, further comprising, after re-adjusting the one or more write parameters, changing the configuration from the two-bit-per-cell configuration to a one-bit-per-cell configuration.

7. The method of claim 1, further comprising:
sending a request to a host device; and
receiving a response from the host device, the response indicating the one or more write parameters.

8. The method of claim 1, wherein the one or more write parameters are associated with each word line of the region.

9. The method of claim 1, wherein the one or more write parameters include a first set of one or more write parameters for a first group of word lines of the region, a second set of one or more write parameters for a second group of word lines of the region, and a third set of write parameters for a third group of word lines of the region.

10. The method of claim 9, wherein the word lines of the first group have a greater distance from a substrate of the memory die than the word lines of the second group, and wherein the word lines of the second group have a greater distance from the substrate than the word lines of the third group.

11. The method of claim 1, wherein the data storage device further includes a controller coupled to the memory die, and wherein the region is a block of the memory.

12. The method of claim 1, wherein the 3D memory configuration is monolithically formed in one or more physical levels of arrays of memory cells having an active area above a silicon substrate, and wherein the memory die further includes circuitry associated with operation of the memory cells.

13. A data storage device comprising:
a memory die, wherein the memory die includes a memory having a three-dimensional (3D) memory configuration; and
a controller coupled to the memory die, wherein the controller is configured to initiate a write operation to write information to a region of the memory during a first stage of an adaptive write process, wherein the controller is further configured to initiate a sense operation to sense the information to generate sensed information, and wherein the controller is further configured to initiate a second stage of the adaptive write process in response to an error rate associated with the sensed information satisfying an error threshold.

14. The data storage device of claim 13, wherein the controller is further configured to initiate the second stage by changing one or more write parameters associated with the region.

15. The data storage device of claim 14, wherein the one or more write parameters indicate a number of pulses of a programming signal or a voltage of one or more of the pulses of the programming signal.

16. The data storage device of claim 14, wherein the controller is further configured to update a table to indicate that the region is associated with the one or more adjusted write parameters.

17. The data storage device of claim 14, wherein the controller is further configured to change a configuration of a word line of the region from a three-bit-per-cell configuration to a two-bit-per-cell configuration to initiate a third stage of the adaptive write process.

18. The data storage device of claim 17, wherein the controller is further configured to re-adjust the one or more write parameters to initiate a fourth stage of the adaptive write process.

19. The data storage device of claim 18, wherein the controller is further configured to change the configuration of the word line from the two-bit-per-cell configuration to a one-bit-per-cell configuration to initiate a fifth stage of the adaptive write process.

20. The data storage device of claim 13, wherein the 3D memory configuration is monolithically formed in one or more physical levels of arrays of memory cells having an active area above a silicon substrate, and further comprising read/write circuitry associated with operation of the memory cells.
